(19) United States
(12) Patent Application Publication
(10) Pub. No.: US 2019/0206285 A1
(43) Pub. Date: Jul. 4, 2019

(54) DESIRED BIRD SPECIES ATTRACTION SYSTEM

(71) Applicant: Classic Brands, LLC, Denver, CO (US)

(72) Inventors: Hunter Owens, Denver, CO (US); John Bruno, Parker, CO (US); Lindsey Nifong, Denver, CO (US); Robert Donegan, Denver, CO (US)

(73) Assignee: Classic Brands, LLC, Denver, CO (US)

(21) Appl. No.: 15/858,736

(22) Filed: Dec. 29, 2017

(51) Int. Cl. G09F 5/00; A01K 39/012; G09F 15/00; G09F 23/00

(52) U.S. Cl. CPC G09F 5/00; G09F 23/00; G09F 15/0006; A01K 39/012

(57) ABSTRACT

Implementations described and claimed herein provide a system for attracting a desired bird species. In one implementation, a matching panel has a body including a first portion and a second portion. A seed indicator is disposed on the first portion of the body of the matching panel. A visual seed representation of a seed type is included in the seed indicator, and a seed match indicator is displayed in association with the visual seed representation. A bird indicator is disposed on the second portion of the body of the matching panel. A visual bird representation of the desired bird species is included in the bird indicator. A bird match indicator is displayed in association with the visual bird representation. The bird match indicator has a linkage with the seed match indicator.

### TECHNICAL FIELD

Aspects of the present disclosure relate to bird species attraction and more particularly to systems, devices, and methods for coordinating bird feeders with bird food and bird species to facilitate attraction of a desired bird species.

### BACKGROUND

Over the last several decades, bird feeding has become one of the most popular hobbies in the United States. Tens of millions of Americans participate in the hobby by feeding wild birds using bird feeders and other products. Although billions of dollars is spent on bird food and hundreds of millions is spent on bird feeders and accessories each year, consumers consistently experience the same frustration: difficulty in identifying the correct bird food and products to attract a desired bird species. Despite the persistence of this frustration, bird food and products have been displayed and sold in the same manner for decades.

More particularly, bird feeders are conventionally displayed and sold independently from bird food, causing consumers to struggle over deciding what to purchase, to purchase the wrong items, and even to give up on the hobby altogether. For example, a consumer may purchase a seed feeder and a bag of wild bird blend without any knowledge of whether that particular seed feeder is capable of dispensing those seeds. The frustration of purchasing a bird feeder that cannot dispense the purchased wild bird blend seeds may be further exacerbated when the consumer discovers that woodpeckers, the bird species the consumer was trying to attract in this instance, does not eat wild bird blend. To attract woodpeckers, the consumer is forced to correct the mistake through additional purchases. There is thus a long felt need in the bird feeding industry for associating bird feeders, bird food, and bird species to enable consumers to attract a desired bird species.

It is with these observations in mind, among others, that the presently disclosed technology was conceived of and developed.

### SUMMARY

Implementations described and claimed herein address the foregoing problems by providing a system for attracting a desired bird species. In one implementation, a bird feeder has a reservoir and at least one port. The reservoir is configured to dispense a chosen bird seed type through the at least one port, and the chosen bird seed type is selected from a set of one or more bird seed types. A feeder panel has a body including a first portion and a second portion. The body is attached to the bird feeder. A seed indicator is disposed on the first portion of the body. The seed indicator includes a visual seed representation of each of the one or more bird seed types. The visual seed representation is displayed in association with a seed match indicator. A bird indicator is disposed on the second portion of the body, and the bird indicator includes a visual bird representation of one or more bird species. The visual bird representation of each of the one or more bird species is displayed in association with a set of one or more bird match indicators. Each of the one or more bird match indicators has a linkage with one of the seed match indicators. The desired bird species is selectable from the visual bird representations and connected to the chosen bird seed type through the linkage of the one or more seed match indicators with the one or more bird match indicators.

In another implementation, a matching panel has a body including a first portion and a second portion. A seed indicator is disposed on the first portion of the body of the matching panel. A visual seed representation of a seed type is included in the seed indicator, and a seed match indicator is displayed in association with the visual seed representation. A bird indicator is disposed on the second portion of the body of the matching panel. A visual bird representation of the desired bird species is included in the bird indicator. A bird match indicator is displayed in association with the visual bird representation. The bird match indicator has a linkage with the seed match indicator.

In still another implementation, a matching panel includes a first portion and a second portion. A seed indicator is disposed on the first portion of the matching panel, and a first visual bird food representation of a first bird food type is included in the seed indicator. A second visual bird food representation of a second bird food type is included in the seed indicator. The first visual bird food representation and the second visual bird food representation are included in a set of visual bird food representations corresponding to a set of bird food types dispensable by a bird feeder selected from a set of one or more optional bird feeders. The set of bird food types includes the first bird food type and the second bird food type. A first seed match indicator is displayed in association with the first visual bird food representation, and a second seed match indicator is displayed in association with the second visual bird food representation. A bird indicator is disposed on the second portion of the matching panel. A visual bird representation of the desired bird species is included in the bird indicator. The visual bird representation is included in a set of visual bird representations corresponding to a set of bird species. A bird match indicator is displayed in association with the visual bird representation. The bird match indicator has a linkage with at least one of the first seed match indicator or the second seed match indicator.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example system for facilitating attraction of a desired bird species.

FIG. 2 illustrates another example system for facilitating attraction of a desired bird species.

FIG. 3 shows an example matching panel.

FIG. 4 shows another example matching panel.

FIG. 5 depicts an example bird feeder with a feeder panel.

FIG. 6 illustrates an example feeder panel.

FIG. 7 shows another example feeder panel.

FIG. 8 depicts another example feeder panel.

FIG. 9 shows another example feeder panel.

FIG. 10 illustrates another example feeder panel.

FIG. 11 shows another example feeder panel.

FIG. 12 depicts an example nectar feeder panel.

### DETAILED DESCRIPTION

Aspects of the presently disclosed technology involve attraction of a desired bird species. Generally, a matching panel has a first portion including a seed indicator and a second portion including a bird indicator. The seed indicator includes visual seed representations of various bird seed types, and the bird indicator includes visual bird representations various bird species. The various bird seed types may be tied to a bird feeder category and/or a particular bird feeder capable of or otherwise configured to dispense the various bird seed types. Each of the visual seed representations is displayed in association with a seed match indicator, and each of the visual bird representations is displayed in association with a set of one or more bird match indicators.

There set of bird match indicators is linked with the seed match indicators to facilitate attraction of a desired bird species. In one aspect, each of the bird match indicators is linked with one of the seed match indicators, such that a desired bird species may be selected from the visual bird representations, and the linkage provides a set of one or more bird seed types that will attract the desired bird species. Each of the seed match indicators may be further matched to a package match indicator associated with a seed package holding one of the bird seed types.

A consumer may thus easily identify a proper system for attracting a desired bird species. In one example, the consumer views the visual bird representations to select a desired bird species. The consumer may then browse the set of one or more bird match indicators, and using the linkage to the seed match indicators, identify a set of one or more bird seed types that will attached the desired bird species. The visual seed representation and/or a linkage of the seed match indicator to a package match indicator guides the consumer through a selection of a chosen bird seed type from the set of one or more bird seed types that will attract the desired bird species. The representations and/or match indicators may be further linked to a particular bird feeder or bird feeder category (e.g., through the use of additional match indicators or by attaching the matching panel to the bird feeder as a feeder panel). As such, the consumer is guided through a selection of a bird feeder and bird seed package that will attract the desired bird species. The system thus solves the decades long frustrations consumers have consistently experienced in connection with the bird feeding hobby.

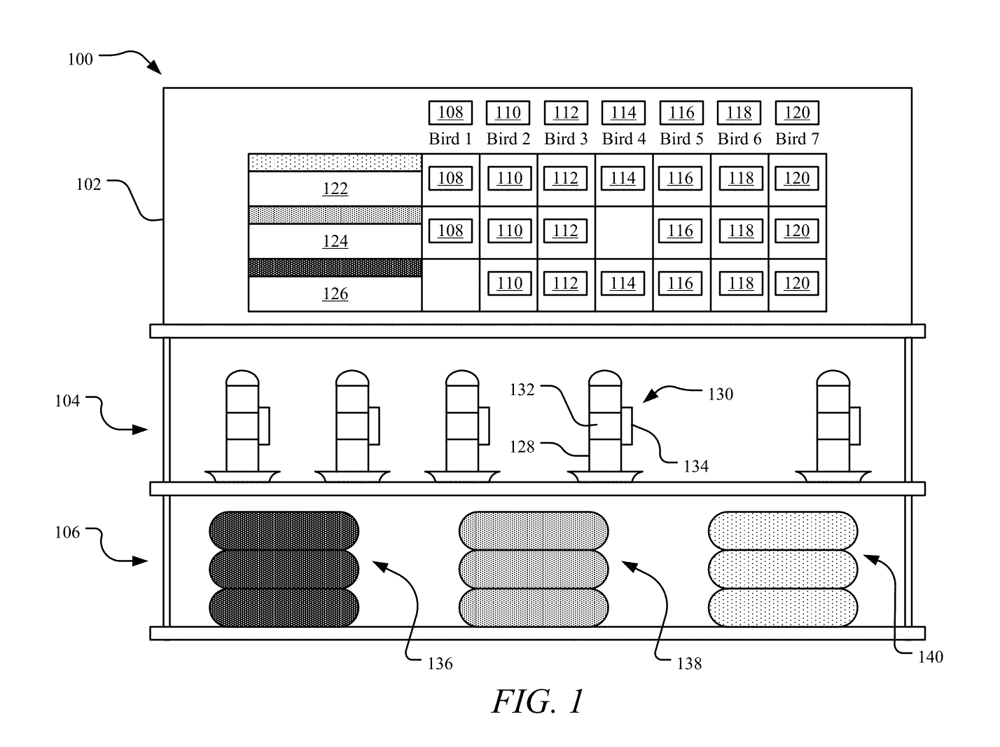

To begin a detailed description of an example system 100 for facilitating attraction of a desired bird species, reference is made to FIG. 1. In one implementation, the system 100 includes a matching panel 102, a set of one or more bird feeders 104, and a set of one or more food packages 106.

The bird feeders 104 may include various categories configured to dispense different types of bird food, such as seeds, nectar, nuts, and/or the like. The bird feeder categories may include, without limitation, tube feeders, screen feeders, hopper feeders, finch tube feeders, suet feeders, squirrel resistant feeders, pest resistant feeders, nectar feeders, seed feeders, and/or other types of feeders configured to dispense one or more bird food types.

The food packages 106 may include housings forming enclosures holding various types of bird food. For example, the food packages 106 may include seed packages, nectar packages, and/or packages holding other types of bird food. The seed packages each include a housing forming an enclosure to hold a bird seed, which may include, without limitation, black oil sunflower, sunflower hearts/chips, wild bird blend, thistle, finch blend, dried mealworms, hulled peanuts, suet nuggets, and/or other types of seeds, nuts, insects, and/or bird food. The nectar packages may be containers of nectar liquid, packets of powder for mixing with liquid to create nectar, and/or the like.

In one implementation, the matching panel 102 having a body including a first portion and a second portion. The first portion may be integral with or separate from the second portion. The matching panel 102 may be in the form of a display panel, a feeder panel, and/or the like. Further, the system 100 may include a series of matching panels. For example, the implementation illustrated in FIG. 1 includes the matching panel 102 shown as a display panel and matching panels in the form of a feeder panel 130 attached to each of the bird feeders 104. The matching panels may be printed, electronic, and/or the like. Electronic versions of the matching panels may be display screens (e.g., monitors), touch-screens, and/or the like. Other variations on the matching panels are contemplated.

In one implementation, the matching panel 102 includes a seed indicator disposed the first portion and a bird indicator disposed on the second portion. The bird indicator includes one or more visual representations of bird species. In the example shown in FIG. 1, the bird indicator includes visual bird representations 108-120 each depicting a different bird species. Each of the visual bird representations 108-120 may be an image of the bird species, a name of the bird species, and/or another visual representation of the bird species.

The seed indicator includes one or more visual representations of bird food types, such as visual seed representations of bird seed. In the example shown in FIG. 1, the seed indicator includes visual seed representations 122-126 each depicting a different bird seeds. Each of the visual seed representations 122-126 may be an image of the bird seed, a name of the bird seed, and/or another visual representation of the bird seed.

In one implementation, each of the visual seed representations 122-126 is displayed in association with a seed match indicator, and each of the visual bird representations 108-120 is displayed in association with a bird match indicator. The matching panel 102 provides a linkage between the seed match indicators and the bird match indicators. For example, the linkage may be a coded color, a coded pattern, a coded graphic, and/or other visual, auditory, and/or tactile linking feature. In the implementation illustrated in FIG. 1, the linkage includes a coded graphic. The bird match indicators include a reproduction of the visual bird representations 108-120 in a table format in connection with the seed match indicators. More particularly, in this example, if the bird species is attracted by one of the bird seed types associated with the visual seed representations 122-126, the visual bird representations 108-120 is reproduced in the row of the table associated with that visual seed representation 122-126. As shown in FIG. 1, each of the bird species associated with the visual bird representations 108-120 is attracted by the bird seed type associated with the visual seed representation 122; the bird species associated with the visual bird representations 108, 110, 112, 116, 118, and 120 are attracted by the bird seed type associated with the visual seed representation 124; and the bird species associated with the visual bird representations 110, 112, 114, 116, 118, and 120 are attracted by the bird seed type associated with the visual seed representation 126.

Using the linking table shown in FIG. 1, a consumer may choose a desired bird species from the visual bird representations 108-120 and easily determine a type of bird seed to purchase for attracting the desired bird species. Specifically, the consumer selects the desired bird species from the visual bird representations 108-120, and the linkage guides the consumer to one or more of the visual seed representations 122-126 for choosing an appropriate bird seed.

While the visual seed representations 122-126 provide guidance to the consumer for identifying the seed package holding the corresponding bird seed, the seed match indicator of the matching panel 102 may further be linked with a package match indicator for easily identifying the proper seed package for attracting the desired bird species. For example, as illustrated in FIG. 1, the seed match indicators may include a coded pattern or other linkage connecting the visual seed representations 122-126 with categories of seed packages 136-140. More particularly, the visual seed representation 122 may be displayed in association with a coded pattern linked to a seed package(s) 140 holding the bird seed type associated with the visual seed representation 122; the visual seed representation 124 may be displayed in association with a coded pattern linked to a seed package(s) 138 holding the bird seed type associated with the visual seed representation 124; and the visual seed representation 126 may be displayed in association with a coded pattern linked to a seed package(s) 136 holding the bird seed type associated with the visual seed representation 126. The package match indicator may be shown on a packaging panel attached to the seed package, a shelf, and/or elsewhere. Alternatively or additionally, the package match indicator may be part of, form, or otherwise be displayed directly on the housing of the seed package. For example, as show in FIG. 1, the housing of the seed package may be the coded pattern.

The matching panel 102 may further include a linkage to the bird feeders 104. The linkage to the bird feeders 104 may be displayed on the first portion, the second portion, or a third portion. In another implementation, the bird feeders 102 include a bird feeder indicator similar to the package match indicator linked to the bird match indicator, the seed match indicator, and/or the package match indicator. In yet another implementation, the bird feeders 104 include the feeder panel 130 providing one or more linkages among bird species, the bird feeder(s) 104, and the seed package(s) 106.

In one implementation, the feeder panel 130 includes a body having a first portion 134 and a second portion 132. As described herein, the first portion 134 may be integral with, attached to, or separate from the second portion 132. The body of the feeder panel 130 may be attached to the bird feeder 104. For example, the first portion 134 may be disposed on a tab on the body, with the tab extending outwardly from a reservoir 128 of the bird feeder 104, and the second portion 132 may be disposed on a sleeve of the body, with the reservoir 138 extending through the sleeve. It will be appreciated by those skilled in the art that the bird feeder 104 will include one or more ports with the reservoir 128 configured to hold and dispense one or more types of bird seed through the one or more ports. In the case of a liquid dispensing bird feeder 104, the bird feeder 104 similarly includes the reservoir 128 configured to dispense nectar or other liquid through one or more ports.

It will further be appreciated that the bird match indicators, the seed match indicators, the package match indicators, and/or the bird feeder match indicators may be provided in various combinations and associations of linkages of coded color, coded graphic, coded pattern, coded display, and/or other orientations or linkages.

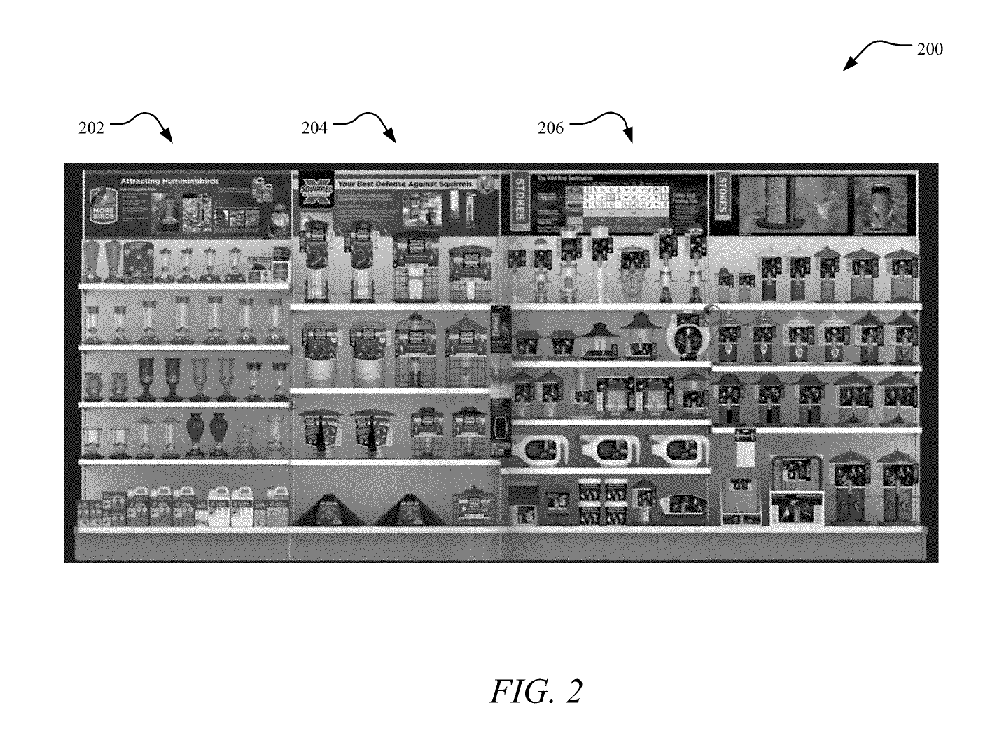

Turning to FIG. 2, illustrating other example system 200 for facilitating attraction of a desired bird species, in one implementation, there is further linkage and categorization based on bird category. More particularly, the matching panel 102, the bird feeders 102, the bird food 106, and/or other bird accessories (e.g., seed totes, pest repellants, etc.) may be provided according to the bird category. In one implementation, the categories include, but are not limited to, a nectar feeder category 202, a pest resistant category 204, and a seed feeder category 206. The nectar feeder category 202 may be directed at hummingbirds, orioles, and other bird species that eat nectar. The pest repellant category 206 may be directed at bird feeders specifically configured to repel or otherwise provide resistance to pests, such as squirrels, ants, and/or other rodents, insects, or pests. Finally, the seed feeder category 206 may be directed at bird species that eat seed, nuts, insects, and/or other solid bird food. The categories 202-206 may be displayed according to and include one or more of the features of the system 100 described herein.

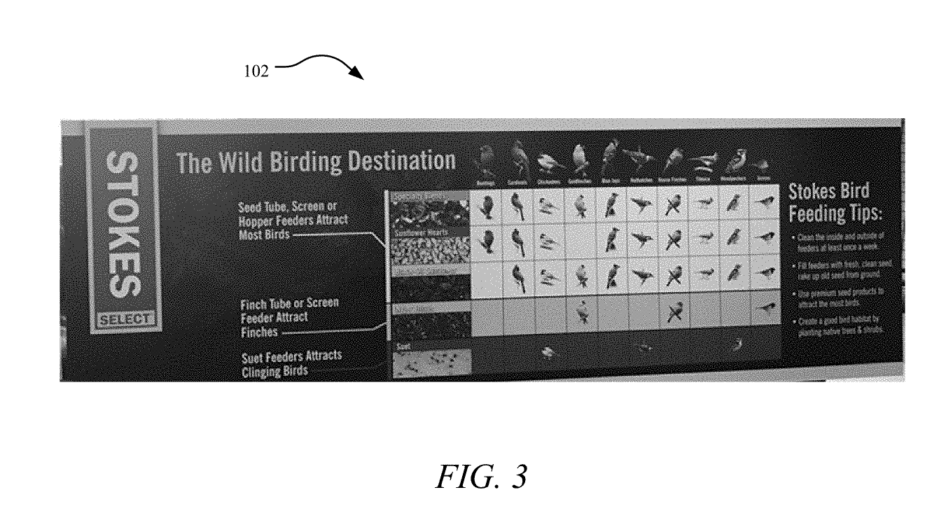

FIG. 3 illustrates an example of the matching panel 102 provided as a display panel with the linkage between the seed match indicator and the bird match indicator provided in a graphical table with a reproduction of the visual bird representations displayed in the row associated with the bird seed type that will attract that bird species. The seed match indicator further includes a linkage to a package indicator in the form of coded color and a linkage to bird feeder indicators in the form of visual name representations detailing one or more categories of associated bird feeders.

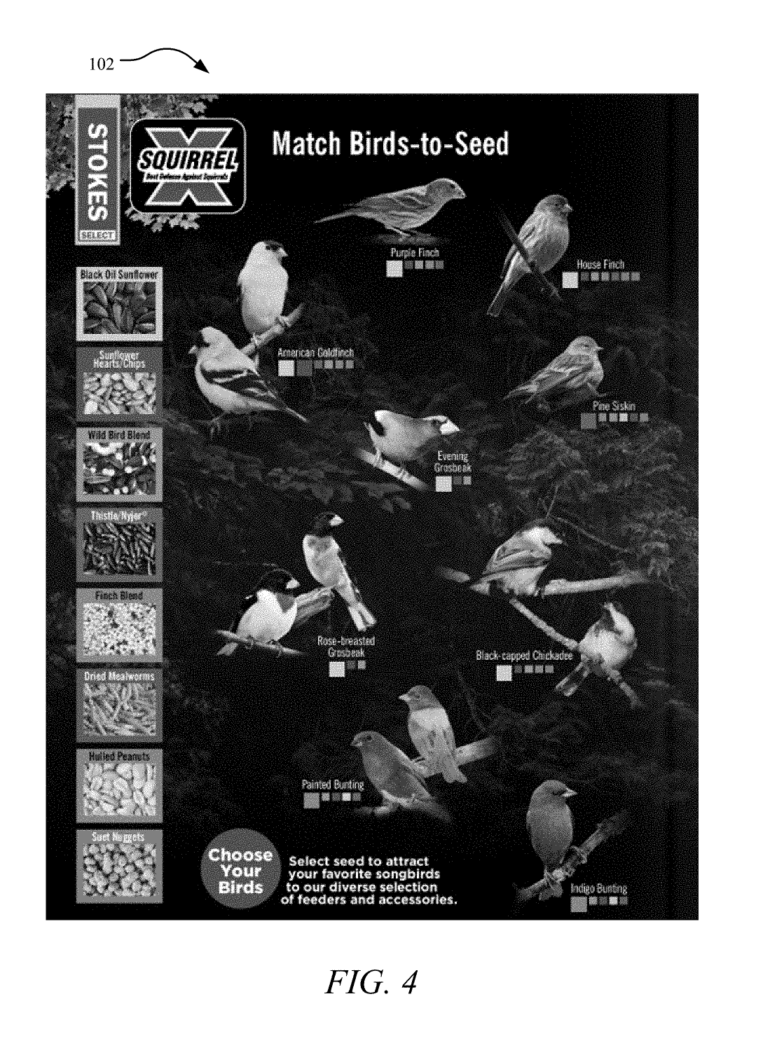

Referring to FIG. 4, another example of the matching panel 102 in the form of a display panel is shown. The visual bird representations are shown in this example as images of the bird species along with names of the bird species, and the visual seed representations are shown as images of the bird seed along with names of the bird species. Each of the visual bird representations is displayed in association with a set of one or more bird match indicators, in this case shown as colored boxes. Similarly, each of the visual seed representations is displayed in association with a seed match indicator, which are shown in FIG. 4 as a colored border around the visual seed representation. The linkage here between the bird match indicators and the seed match indicators is a coded color. More particularly, each of the bird match indicators has a color that is connected to one of the seed match indicators.

The set of one or more bird match indicators is provided based on the corresponding bird seed types that the bird species depicted in the associated visual bird representation will be attracted by. The set of bird match indicators may be displayed in a hierarchy, for example, according to attraction level for the associated bird species. A bird seed type that is more likely to attract the associated bird species may be displayed in a higher level of the hierarchy than one that is less likely to attract the bird species. For example, as shown in FIG. 4, the boxes of the bird match indicator may be displayed in different sizes with the boxes having a linkage to a bird seed type more likely to attract the bird species depicted in the visual bird representation being displayed with a larger or otherwise more prominent size, shape, or presentation. Thus, the consumer may use the matching panel 102 to select one or more desired bird species and match it to the bird food mostly likely to attract the desired bird species.

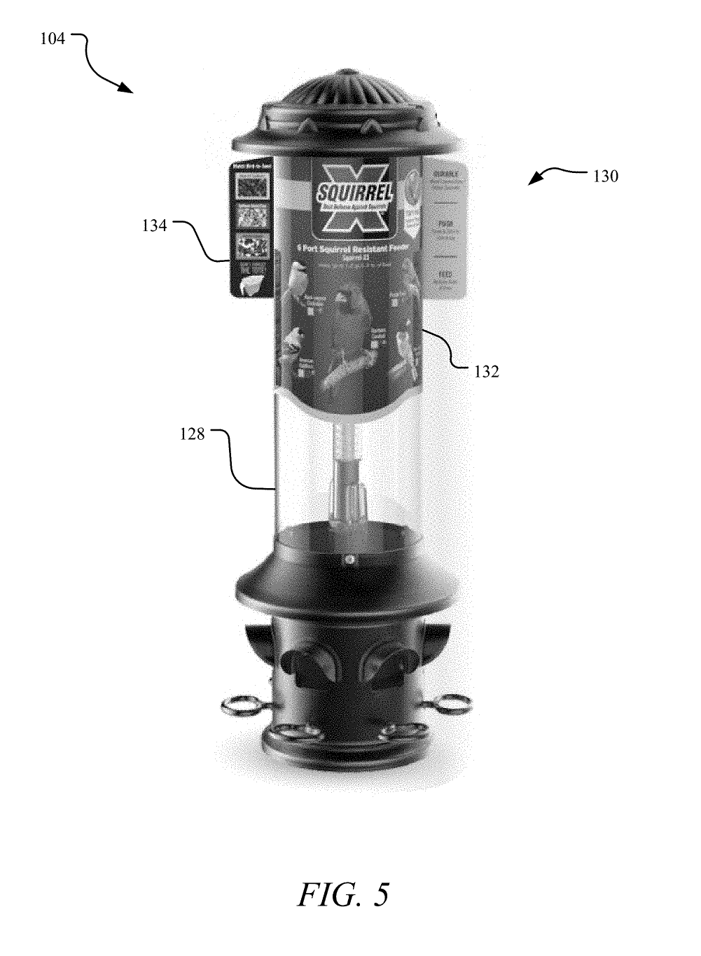

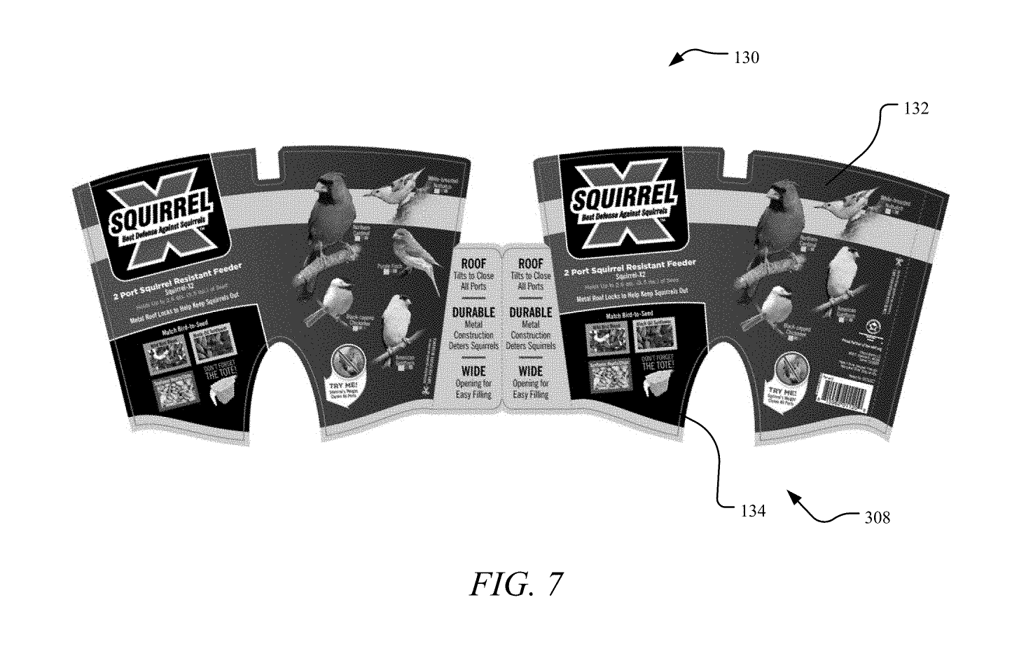

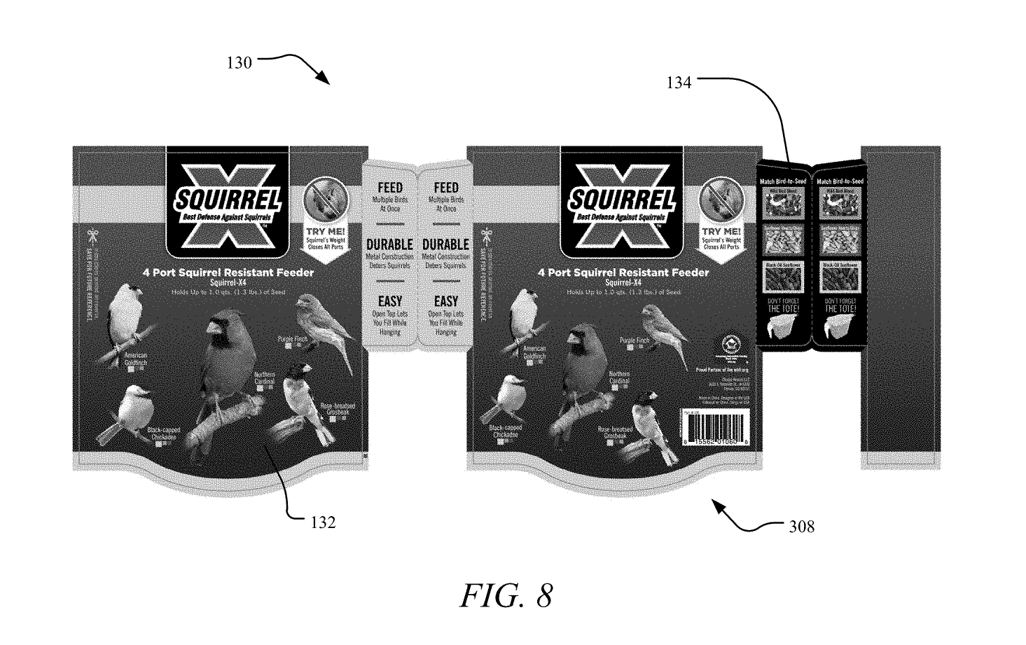

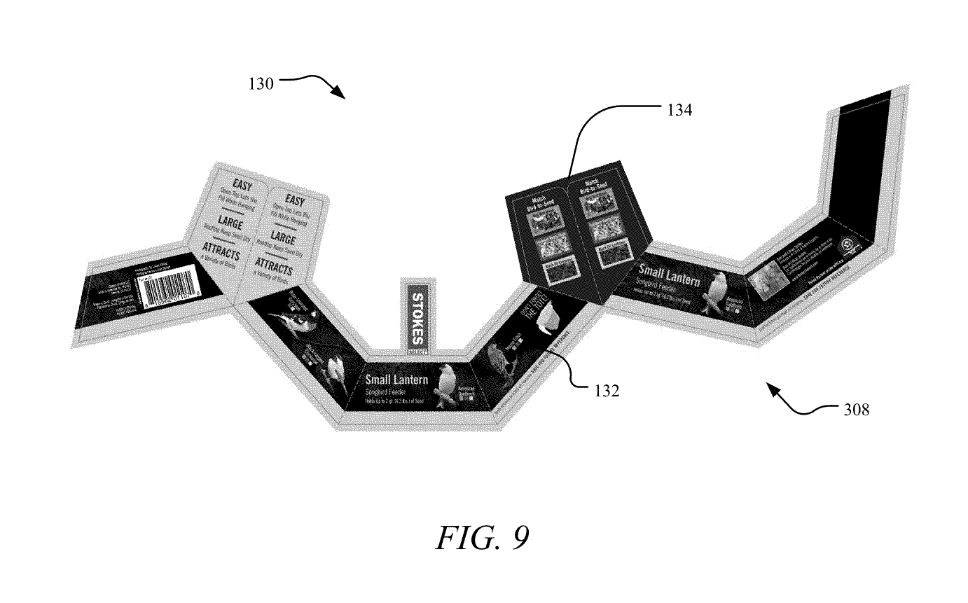

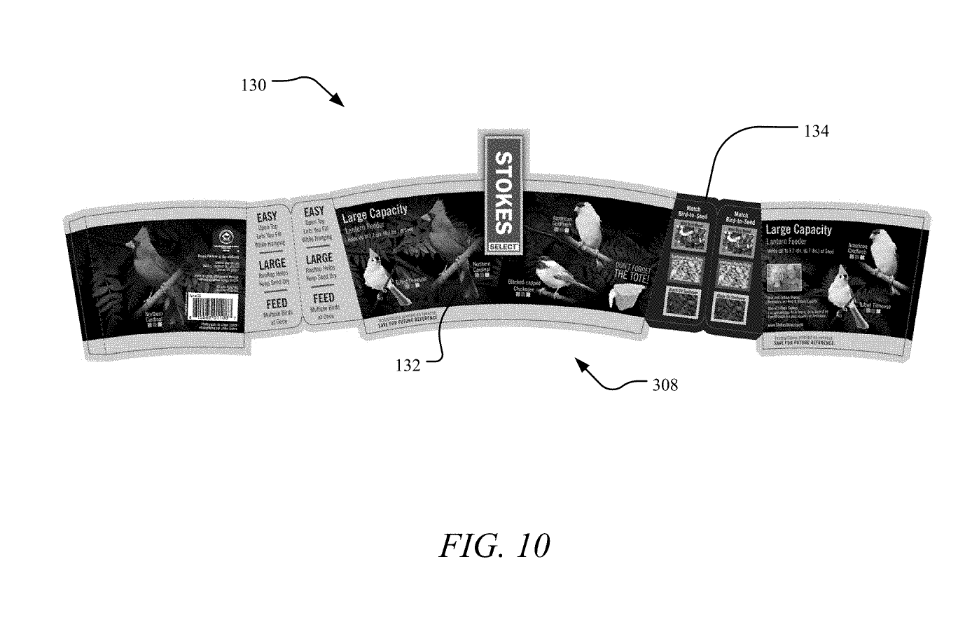

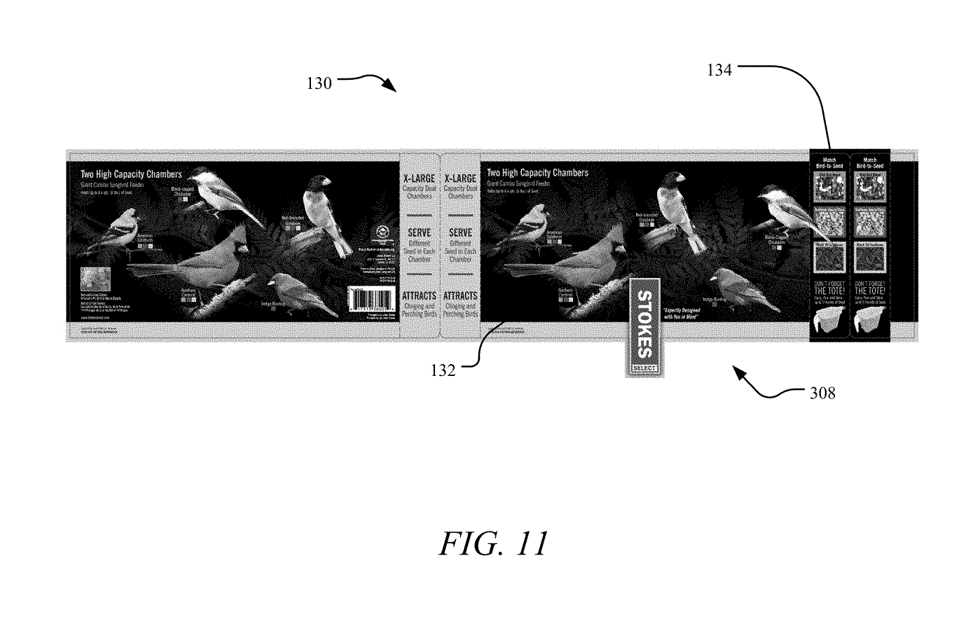

As described herein, the matching panel 102 may be provided as a feeder panel 130 attached to a bird feeder 104. As example of this is shown in FIG. 5, with the feeder panel 130 mounted on the reservoir 128 of the bird feeder 104. Here, the first portion 134 of the body of the feeder panel 130 is configured as a tab, and the second portion 132 of the body of the feeder panel 130 is configured as a sleeve. It will be appreciated, particularly in light of the implementations shown in FIGS. 5-11 that the shape, size, orientation, attachment, and features of the feeder panel 130, as well as the matching panel 102 generally, are exemplary only and other variations providing the match indicators and linkages described herein are contemplated.

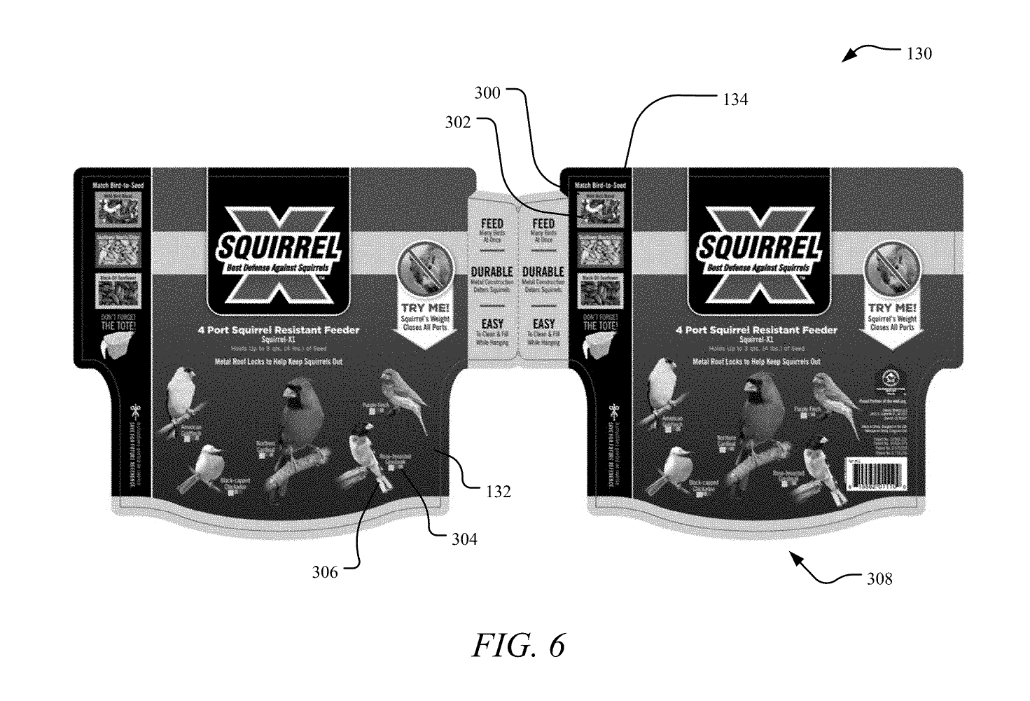

As described herein and can be understood from FIGS. 6-11, in one implementation, the feeder panel 130 or another matching panel includes a body 308 having the first portion 134 and the second portion 132, which may be integral, separate, attached, or otherwise part of the overall body 308. The first portion 134 includes the visual seed representations 302, each displayed in association with the seed match indicator 300, and the second portion 132 includes the visual bird representations 306, each displayed in association with a set of one or more bird match indicators 304, which may be displayed in a hierarchy as described herein.

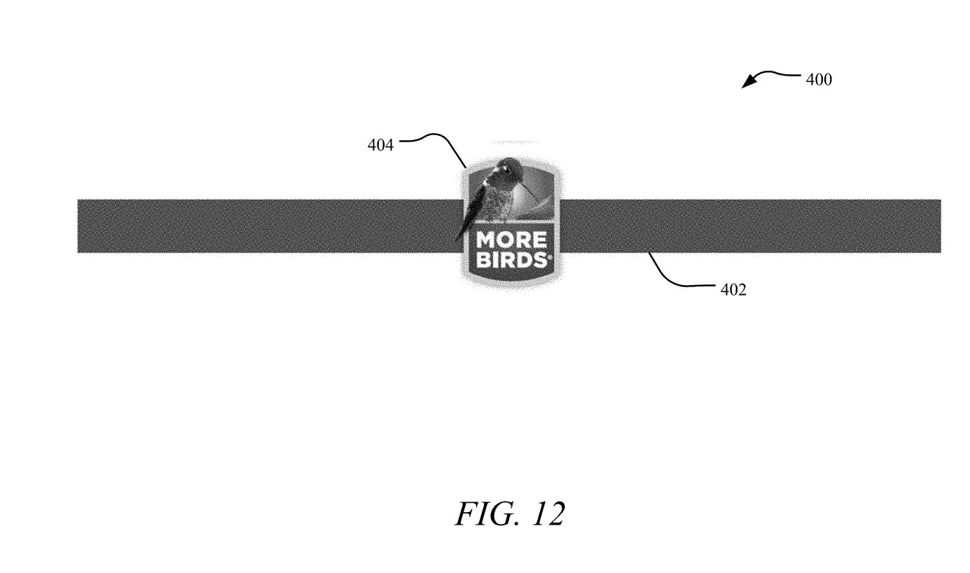

FIG. 12 shows a nectar feeder panel 400 having a first portion 404 and a second portion 402. The first portion 404 includes a seed match indicator with a linkage to one or more nectar packages and the second portion 402 includes a sleeve or other connecting body for attaching to the bird feeder 104.

It will be appreciated that the feeder panels 130 shown in FIGS. 5-12 and the matching panels 102 shown as display panels in FIGS. 1-4 illustrate the various ornamental features that may be incorporated into the systems 100/200. With the various panels 102/130/400 illustrated herein, a desired bird species is selected from one or more visual bird representations 306. The visual bird representation 306 of the desired bird species is connected to one or more visual seed representations 302 through a linkage between one or more bird match indicators 304 and one or more seed match indicators 300. The linkage is used to identify the one or more visual seed representations 302 associated with the bird seed types that will attract the desired bird species. A bird seed type is then chosen using the one or more visual seed representations 302, and a seed package 106 is selected using a package indicator linked to the seed match indicator 300 associated with the chosen visual seed representation. A bird feeder 104 is similarly chosen through the use of the feeder panel 130 being directly attached or otherwise linked to the bird feeder 104 and/or based on one of the seed match indicators 300, the bird match indicators 304, and/or the package match indicators.

Based upon design preferences, it is understood that the specific order or hierarchy of steps in the methods described herein can be rearranged while remaining within the disclosed subject matter. Any accompanying method claims present elements of the various steps in a sample order and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The above specification, examples, and data provide a complete description of the structure and use of example implementations of the invention. Various modifications and additions can be made to the exemplary implementations discussed without departing from the spirit and scope of the presently disclosed technology. For example, while the implementations described above refer to particular features, the scope of this disclosure also includes implementations having different combinations of features and implementations that do not include all of the described features. Accordingly, the scope of the presently disclosed technology is intended to embrace all such alternatives, modifications, and variations together with all equivalents thereof.

What is claimed is:

1. A system for facilitating attraction of a desired bird species, the system comprising:
a bird feeder having a reservoir and at least one port, the reservoir configured to dispense a chosen bird seed type through the at least one port, the chosen bird seed type selected from a set of one or more bird seed types;
a feeder panel having a body including a first portion and a second portion, the body attached to the bird feeder;
a seed indicator disposed on the first portion of the body, the seed indicator including a visual seed representation of each of the one or more bird seed types, the visual seed representation displayed in association with a seed match indicator; and
a bird indicator disposed on the second portion of the body, the bird indicator including a visual bird representation of one or more bird species, the visual bird representation of each of the one or more bird species displayed in association with a set of one or more bird match indicators, each of the one or more bird match indicators having a linkage with one of the seed match indicators, the desired bird species selectable from the visual bird representations and connected to the chosen bird seed type through the linkage of the one or more seed match indicators with the one or more bird match indicators.

2. The system of claim 1, further comprising:
a set of one or more seed packages each having a housing forming an enclosure holding one of the one or more bird seed types and associated with a package match indicator linked to one of the seed match indicators.

3. The system of claim 2, wherein the package match indicator is displayed on at least one of the housing or a package panel.

4. The system of claim 1, wherein the visual seed representation includes an image of the bird seed type.

5. The system of claim 1, wherein the visual bird representation includes an image of the bird species.

6. The system of claim 1, wherein the linkage includes at least one of coded color, coded pattern, or coded graphic.

7. The system of claim 1, wherein the first portion is disposed on a tab of the body, the tab extending outwardly from the reservoir.

8. The system of claim 1, wherein the second portion is disposed on a sleeve of the body, the reservoir extending through the sleeve.

9. The system of claim 1, wherein the first portion is integral with the second portion.

10. A system for facilitating attraction of a desired bird species, the system comprising:
a matching panel having a body including a first portion and a second portion;
a seed indicator disposed on the first portion of the body of the matching panel;
a visual seed representation of a seed type, the visual seed representation included in the seed indicator;
a seed match indicator displayed in association with the visual seed representation;
a bird indicator disposed on the second portion of the body of the matching panel;
a visual bird representation of the desired bird species, the visual bird representation included in the bird indicator; and
a bird match indicator displayed in association with the visual bird representation, the bird match indicator having a linkage with the seed match indicator.

11. The system of claim 10, wherein the visual bird representation of the desired bird species is selectable from a set of optional visual bird representations each corresponding to a particular bird species.

12. The system of claim 10, wherein the bird match indicator is included in a set of bird match indicators corresponding to the desired bird species.

13. The system of claim 12, wherein the set of bird match indicators is displayed in a hierarchy.

14. The system of claim 10, wherein the linkage includes at least one of coded color, coded pattern, or coded graphic.

15. The system of claim 10, wherein the visual bird representation includes at least one of an image of the desired bird or a name of the desired bird and the visual seed representation includes at least one of an image of the seed type or a name of the seed type.

16. The system of claim 10, wherein the seed match indicator is linked to a package match indicator associated with a seed package having a housing forming an enclosure holding the seed type.

17. The system of claim 10, wherein the matching panel is a feeder panel attached to a bird feeder configured to dispense the seed type.

18. The system of claim 10, wherein at least one of the bird indicator or the seed indicator is linked to one or more bird feeders.

19. A system for facilitating attraction of a desired bird species, the system comprising:
a matching panel including a first portion and a second portion;
a seed indicator disposed on the first portion of the matching panel;
a first visual bird food representation of a first bird food type included in the seed indicator;
a second visual bird food representation of a second bird food type included in the seed indicator, the first visual bird food representation and the second visual bird food representation included in a set of visual bird food representations corresponding to a set of bird food types dispensable by a bird feeder selected from a set of one or more optional bird feeders, the set of bird food types including the first bird food type and the second bird food type;
a first seed match indicator displayed in association with the first visual bird food representation;
a second seed match indicator displayed in association with the second visual bird food representation;
a bird indicator disposed on the second portion of the matching panel;
a visual bird representation of the desired bird species included in the bird indicator, the visual bird representation included in a set of visual bird representations corresponding to a set of bird species; and
a bird match indicator displayed in association with the visual bird representation, the bird match indicator having a linkage with at least one of the first seed match indicator or the second seed match indicator.

20. The system of claim 19, wherein the first portion is separate from the second portion.
